(19) United States
(12) Patent Application Publication
(10) Pub. No.: US 2014/0260956 A1
(43) Pub. Date: Sep. 18, 2014

(54) CIRCUMFERENTIAL SEALING OF PISTON ASSEMBLY IN A PISTON ACTUATOR

(71) Applicant: WOODWARD, INC., Fort Collins, CO (US)

(72) Inventor: Mark Williams, Thousand Oaks, CA (US)

(73) Assignee: Woodward, Inc., Fort Collins, CO (US)

(21) Appl. No.: 13/827,223

(22) Filed: Mar. 14, 2013

(51) Int. Cl. F16J 1/04

(52) U.S. Cl. CPC F16J 1/04
USPC 92/172; 92/261

(57) ABSTRACT

Methods, apparatuses, and systems for circumferential sealing of piston assembly in a piston actuator. A piston assembly for a piston actuator includes a piston including an extending surface, a retracting surface, and a circumferential surface that connects the extending surface and the retracting surface. The piston is adapted to engage and seal against an interior surface of a cylinder bore of an actuator. The piston assembly includes a first unidirectional passage connecting the extending surface and the circumferential surface. The first unidirectional passage allows hydraulic fluid to flow unidirectionally from the extending surface to the circumferential surface through the piston to energize a circumferential seal disposed on a seal groove in the circumferential surface during an extension stroke of the piston

### TECHNICAL FIELD

This disclosure relates to a piston assembly engaged with an interior of a piston actuator.

### BACKGROUND

A piston assembly of a piston actuator includes a piston that is adapted to engage and seal against an interior surface of a cylinder bore of the actuator. The piston can include a circumferential seal that can be energized to seal against an inner side wall of a cylinder bore of the actuator. One method to facilitate the energizing of the seal is to add notches in the side wall of the seal so that pressure is able to quickly build up under the seal to energize the seal. However, this method is not possible in implementations in which the piston assembly is disposed in an actuator that includes features, for example, ports, in the inner wall of the cylinder bore. Another method to facilitate the energizing of the seal is to implement an energizing spring, for example, to help low pressure sealing. In high pressure environments, however, the pressures of the hydraulic fluid in the cylinder bore can exceed the spring force. The spring force may consequently be insufficient to overcome radial compressive forces created by the high pressures. A further method to facilitate the energizing of the seal is to dimension the height of the seal so that it is physically restrained from being compressed in the groove. Doing so can prevent a flow path across an outside diameter of the seal. The cost of implementing this method can be high because the seal may need to be machined to close tolerances.

### SUMMARY

This disclosure describes circumferential sealing of a piston assembly in a piston actuator.

In general, one innovative aspect of the subject matter described here can be implemented as a piston assembly disposed in a piston assembly of a piston actuator. The piston assembly includes a piston including an extending surface, a retracting surface, and a circumferential surface that connects the extending surface and the retracting surface. The piston is adapted to engage and seal against an interior surface of a cylinder bore of an actuator. The piston assembly includes a first unidirectional passage connecting the extending surface and the circumferential surface. The first unidirectional passage allows hydraulic fluid to flow unidirectionally from the extending surface to the circumferential surface through the piston to energize a circumferential seal disposed on a seal groove in the circumferential surface during an extension stroke of the piston.

This, and other aspects, can include one or more of the following features. The piston assembly can include a check valve disposed in the first unidirectional passage. The check valve can be adapted to flow the hydraulic fluid from the extending surface to the circumferential surface and prevent back flow of the hydraulic fluid from the circumferential surface to the extending surface. The piston assembly can include a second unidirectional passage connecting the retracting surface and the circumferential surface. The second unidirectional passage can allow hydraulic fluid to flow unidirectionally from the retracting surface to the circumferential surface through the piston to energize the circumferential seal disposed on the seal groove in the circumferential surface during a retraction stroke of the piston. The piston assembly can include a check valve disposed in the second unidirectional passage. The check valve can be adapted to flow the hydraulic fluid from the retracting surface to the circumferential surface and prevent back flow of the hydraulic fluid from the circumferential surface to the retracting surface. An inlet of the first unidirectional passage can be positioned in the extending surface diametrically opposite to an inlet of the second unidirectional passage positioned in the retracting surface. An outlet of the first unidirectional passage can be positioned in the circumferential surface diametrically opposite to an outlet of the second unidirectional passage positioned in the circumferential surface. The outlet of the first unidirectional passage can terminate in the seal groove and the outlet of the second unidirectional passage can terminate in the seal groove.

Another innovative aspect of the subject matter described here can be implemented as a piston assembly disposed in a cylinder assembly of a piston actuator. The piston assembly includes a piston including a extending surface, a retracting surface, and a circumferential surface that connects the extending surface and the retracting surface. The piston assembly includes a cylinder bore of an actuator assembly. The cylinder bore, which is adapted to receive the piston, includes a first chamber formed between a front end of the cylinder bore and the extending surface, and a second chamber formed between a rear end of the cylinder bore and the retracting surface when the piston is disposed in the bore intermediate to the front end and the rear end. The piston assembly includes a first unidirectional passage connecting the retracting surface and the circumferential surface. The first unidirectional passage allows hydraulic fluid in the rear chamber to flow unidirectionally in the cylinder bore from the retracting surface to the circumferential surface through the piston to energize a circumferential seal disposed in a seal groove in the circumferential surface during a retraction stroke of the piston.

This, and other aspects can include one or more of the following features. The piston assembly can include a second unidirectional passage connecting the extending surface and the circumferential surface. The second unidirectional passage allows hydraulic fluid in the front chamber to flow unidirectionally from the extending surface to the circumferential surface through the piston to energize the circumferential seal disposed in the seal groove in the circumferential surface during an extension stroke of the piston. The piston assembly can include a check valve disposed in the second unidirectional passage adapted to allow the hydraulic fluid in the front chamber to flow from the extending surface to the circumferential surface and prevent back flow from the circumferential surface to the extending surface. An inlet of the first unidirectional passage can be positioned in the retracting surface diametrically opposite to an inlet of the second unidirectional passage positioned in the extending surface. An outlet of the first unidirectional passage can be positioned in the circumferential surface diametrically opposite to an outlet of the second unidirectional passage positioned in the circumferential surface. The piston assembly can include a check valve disposed in the first unidirectional passage that allows the hydraulic fluid in the rear chamber to flow from the retracting surface to the circumferential surface and prevents back flow from the circumferential surface to the retracting surface. The cylinder bore can include a circumferential wall that connects the front end and the rear end. The circumferential wall can include an opening which engages the circumferential seal when the circumferential seal is energized by the hydraulic fluid flowing through the first unidirectional passage.

A further innovative aspect of the subject matter described here can be implemented as a method to energize a seal on a piston. Hydraulic fluid is received in an inlet of a first unidirectional passage. The inlet of the first unidirectional passage is disposed in an extending surface of a piston disposed in a cylinder bore of a piston actuator. The extending surface is connected to a retracting surface of the piston by a circumferential surface. The hydraulic fluid is received in the inlet of the first unidirectional passage when a hydraulic fluid pressure in a first chamber proximal to the extending surface is greater than a hydraulic fluid pressure in a second chamber proximal to the retracting surface. The hydraulic fluid is flowed unidirectionally from the inlet of the first unidirectional passage in the extending surface to an outlet of the first unidirectional passage. The outlet of the first unidirectional passage is disposed in the circumferential surface of the piston. A circumferential seal disposed on a seal groove in the circumferential surface is energized.

This, and other aspects, can include one or more of the following features. Hydraulic fluid can be received in an inlet of a second unidirectional passage. The inlet of the second unidirectional passage can be disposed in the retracting surface of the piston. The hydraulic fluid can be received in the inlet of the second unidirectional passage when the hydraulic fluid pressure in the second chamber is greater than the hydraulic fluid pressure in the first chamber. The hydraulic fluid can be flowed unidirectionally from the inlet of the second unidirectional passage in the retracting surface to an outlet of the second unidirectional passage. The outlet of the second unidirectional passage can be disposed in the circumferential surface of the piston. The circumferential seal disposed on the seal groove in the circumferential surface can be energized. Flowing the hydraulic fluid unidirectionally from the inlet of the second unidirectional passage can include flowing the hydraulic fluid through a check valve disposed in the second unidirectional passage. Receiving the hydraulic fluid in the inlet of the second unidirectional passage can include receiving the hydraulic fluid in the inlet of the second unidirectional passage during a retraction stroke of the piston. Flowing the hydraulic fluid unidirectionally from the inlet of the first unidirectional passage can include flowing the hydraulic fluid through a check valve disposed in the first unidirectional passage. Receiving the hydraulic fluid in the inlet of the first unidirectional passage can include receiving the hydraulic fluid in the inlet of the first unidirectional passage during an extension stroke of the piston.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example cross-sectional view of a cylinder assembly of a piston actuator.

FIG. 2 illustrates a close-up view of the first unidirectional flow passage 114 and the second unidirectional flow passage 119 in the piston 102.

FIG. 3 is a flowchart of an example process to energize a seal on the piston.

Like reference numbers and designations in the various drawings indicate like elements.

### DETAILED DESCRIPTION

This disclosure describes methods, apparatuses, and systems for circumferential sealing of a piston assembly in a piston actuator. As described above, the piston assembly includes a piston adapted to engage and seal against an interior surface of a cylinder bore of the piston actuator. To facilitate the sealing, a circumferential seal can be disposed on a seal groove in a circumferential surface of the piston. To properly seal the interior chambers of the cylinder bore, the seal is reliant on there being adequate pressure under the seal to energize the seal against the interior surface (i.e., the inner side wall) of the cylinder bore.

In certain conditions (for example, combinations of actuator load and pressure, friction, piston velocity and direction) the circumferential seal can experience a “blow-by” phenomenon in which the pressure gradient around the seal under those conditions does not allow the seal to energize. This phenomenon can occur, for example, when a higher pressure of a hydraulic fluid in a chamber between the piston and an end of the cylinder bore is not able to get under the circumferential seal fast enough due to a fit of the seal within the seal groove. The failure of the high pressure to get under the seal can result in the creation of a differential pressure on top of the seal, which compresses the seal radially in the seal groove and allows flow of the hydraulic fluid across the seal. Such compression of the seal in a direction away from the inner side wall of the cylinder bore can result in performance degradation of the piston actuator.

This disclosure describes techniques to circumferentially seal the piston assembly in the piston actuator to minimize or eliminate the “blow-by” phenomenon. To do so, in some implementations, a pair of back-to-back check valves is employed within the piston to ensure that high pressure always gets under the circumferential seal to energize the seal during either the extension stroke or the retraction stroke of the piston in the actuator.

As described below, the check valves can be disposed in the piston to not allow leakage from one cylinder chamber to another during a piston stroke. Each check valve can ensure that a higher of two cylinder chamber pressures (described below) can act quickly on an underside of the circumferential seal to energize the seal against the seal groove side wall and cylinder bore. No notches need be formed in the seal side wall. A seal energizing spring can be realistically sized. The techniques described here can be implemented when the inner side wall of the cylinder bore includes features, for example, openings in the inner wall of the cylinder bore, known sometimes as “hole-in-the-wall” ports. The techniques may negate a need to include a spring or to machine the seal to close tolerances to facilitate sealing. In some implementations, the techniques described here can be combined with the spring or closely machined seals to further facilitate sealing of the piston.

FIG. 1 illustrates an example cross-sectional view of a cylinder assembly 100 of a piston actuator. The cylinder assembly 100 can be implemented in high pressure environments, for example, a flight control actuation system of an aircraft. The cylinder assembly 100 can include a piston assembly 101, which can include a piston 102 including an extending surface 104, a retracting surface 106, and a circumferential surface 108 that connects the extending surface 104 and the retracting surface 106. The piston 102 can be adapted to engage and seal against an interior surface 110 of a cylinder bore 112 of the cylinder assembly 100.

In some implementations, the cylinder assembly can include a first unidirectional passage 114 connecting the extending surface 104 and the circumferential surface 108. The first unidirectional passage 114 can allow hydraulic fluid to flow unidirectionally from the extending surface 104 to the circumferential surface 108 through the piston 102 to energize a circumferential seal 116 disposed on a seal groove 130 in the circumferential surface 108. In some example situations, the first unidirectional passage 114 can allow the hydraulic fluid to flow unidirectionally during an extension stroke of the piston 102. In some example situations, because of external load conditions and direction of travel of the piston 102 in the cylinder bore 112, the highest pressure in the cylinder bore 112 can be in a first chamber 132 proximal to the extending surface 104 and distal to the retracting surface 106 during the retraction stroke of the piston 102. In such example situations, the first unidirectional passage 114 can allow the hydraulic fluid to flow unidirectionally during the retraction stroke of the piston 102. For example, a check valve 118 can be disposed in the first unidirectional passage 114. The check valve 118 can be adapted to flow the hydraulic fluid from the extending surface 104 to the circumferential surface 108, and prevent back flow of the hydraulic fluid from the circumferential surface 108 to the extending surface 104 during the high pressure conditions described above.

The cylinder assembly 100 can include a second unidirectional passage 119 connecting the retracting surface 106 and the circumferential surface 108. The second unidirectional passage 119 can allow hydraulic fluid to flow unidirectionally from the retracting surface 106 to the circumferential surface 108 through the piston 102 to energize the circumferential seal 116 disposed on the seal groove 130 in the circumferential surface 108. In some example situations, the second unidirectional passage 119 can allow the hydraulic fluid to flow unidirectionally during a retraction stroke of the piston 102. In some example situations, because of external load conditions and direction of travel of the piston 102 in the cylinder bore 112, the highest pressure in the cylinder bore 112 can be in a second chamber 134 proximal to the retracting surface 106 and distal to the extending surface 104 during the extension stroke of the piston 102. In such example situations, the second unidirectional passage 119 can allow the hydraulic fluid to flow unidirectionally during the extension stroke of the piston 102. For example, a check valve 120 can be disposed in the second unidirectional passage 119. The check valve 120 can be adapted to flow the hydraulic fluid from the retracting surface 106 to the circumferential surface 108, and prevent back flow of the hydraulic fluid from the circumferential surface 108 to the retracting surface 106 during the high pressure conditions described above.

In some implementations, the first unidirectional passage 114 and the second unidirectional passage 119 can be formed in the same piston 102. For example, an inlet (for example, an extend port 122) of the first unidirectional passage 114 can be positioned in the extending surface 104 diametrically opposite to an inlet (for example, a retract port 124) of the second unidirectional passage 119 positioned in the retracting surface 106. In addition, an outlet of the first unidirectional passage 114 can be positioned in the circumferential surface 108 diametrically opposite to an outlet of the second unidirectional passage 119 positioned in the circumferential surface 108. The check valve 118 and the check valve 120 can be disposed in the first unidirectional passage 114 and the second unidirectional passage 119, respectively, on the extending surface 106 and the retracting surface 106, respectively.

In some implementations, more than one unidirectional passage can be formed on the extending surface 104, each passage terminating in the seal groove 130 in the circumferential surface 108. In such implementations, inlets of the unidirectional passages can be formed at different positions on the extending surface 104 and outlets of the unidirectional passages can be formed at different positions in the circumferential surface 108 to minimize regions of stress concentration that develop due to the formation of the inlets and the outlets. Similarly, in some implementations, more than one unidirectional passage can be formed on the retracting surface 106, each passage terminating in the seal groove 130 in the circumferential surface 108.

FIG. 2 illustrates a close-up view of the first unidirectional flow passage 114 and the second unidirectional flow passage 119 in the piston 102. During an extension stroke of the piston 102 (i.e., toward the extension end 202 of the cylinder bore 110), a pressure of the hydraulic fluid in the first chamber 132 can increase forcing the hydraulic fluid in the first unidirectional passage 114 formed between the extending surface 104 and the circumferential surface 108. The hydraulic fluid can flow through the first unidirectional flow passage 114 to the seal groove 130 in which the circumferential seal 116 is disposed. The circumferential seal 116 can be energized by the high pressure of the hydraulic fluid and forced against the interior surface 110 of the cylinder bore 112. During a retraction stroke of the piston 102 (i.e., toward the rear end 204 of the cylinder bore 110), the check valve 118 can prevent flow back of the hydraulic fluid through the first unidirectional passage 114 from the circumferential surface 108 to the extending surface 104 of the piston 102.

Similarly, during the retraction stroke of the piston 102, a pressure of the hydraulic fluid in the second chamber 134 can increase forcing the hydraulic fluid in the second unidirectional passage 119 formed between the retracting surface 106 and the circumferential surface 108 can receive the hydraulic fluid. The hydraulic fluid can flow through the second unidirectional passage 119 to the seal groove 130 in which the circumferential seal 116 is disposed. The circumferential seal 116 can be energized by the high pressure of the hydraulic fluid and forced against the interior surface 110 of the cylinder bore 112. During the next extension stroke of the piston 102, the check valve 120 can prevent flow back of the hydraulic fluid through the second unidirectional passage 119 from the circumferential surface 108 to the retracting surface 106.

This operation of the pair of check valves disposed in the unidirectional passages can minimize or prevent the “blow-by” phenomenon described above. In some implementations, a circumferential interior surface 110 of the cylinder bore 112 in a region between the extending end 202 and the retracting end 204 of the 218 can include one or more openings 126 (i.e., the “hole-in-the-wall” ports described above). The opening 126 can engage the circumferential seal 116 when the circumferential seal 116 is energized by the hydraulic fluid flow either in the extension stroke or in the retraction stroke, as described above. Because an underside of the circumferential seal 116 is energized and forced toward the circumferential wall 110, the circumferential seal 116 can seal the opening 126 during either the extension stroke or the retraction stroke of the piston 102.

In some implementations, depending on external load conditions and direction of travel of the piston 102, the highest pressure (and therefore direction of flow) may be on the opposite to what is described above. For example, the hydraulic fluid pressure in the second chamber 134 can be greater than the hydraulic fluid pressure in the first chamber 132 during an extension stroke of the piston 102. Conversely, the hydraulic fluid pressure in the first chamber 132 can be greater than the hydraulic fluid pressure in the second chamber 134 during a retraction stroke of the piston 102. In some implementations, the piston 102 may be stationary within the cylinder bore 112 such that the circumferential seal 116 engages the hole-in-the-wall port 126. The check valves disposed in the unidirectional passages can prevent back flow of the hydraulic fluid from the circumferential surface 108 to the extending surface 104 or the retracting surface 106 (or both) under any of these conditions in which a pressure differential exists on either side of the piston 102.

FIG. 3 is a flowchart of an example process 400 to energize a seal on the piston. In some implementations, the process 300 can be implemented using the cylinder assembly described with reference to FIGS. 1 and 2. At 302, hydraulic fluid can be received in an inlet of a first unidirectional passage from an extending surface of a piston to a circumferential surface of the piston when a hydraulic fluid pressure in a chamber proximal to the extending surface is greater than a hydraulic fluid pressure in a chamber proximal to the retracting surface, for example, during a extension stroke. At 404, the hydraulic fluid can be flowed unidirectionally from the inlet of the first unidirectional passage in the extending surface to an outlet of the first unidirectional passage. At 306, a circumferential seal disposed on a seal groove in the circumferential surface can be energized.

At 308, the hydraulic pressure in the chamber proximal to the retracting surface can become greater than the hydraulic fluid pressure in the chamber proximal to the extending surface. For example, the extension stroke can end and the retraction stroke can begin. At 310, hydraulic fluid can be received in an inlet of a second unidirectional passage from a retracting surface of the piston to the circumferential surface of the piston. At 312, the hydraulic fluid can be flowed unidirectionally from the inlet to an outlet disposed in a circumferential surface of the piston. At 314, the circumferential seal disposed on the seal groove in the circumferential surface can be energized. At 316, the hydraulic pressure in the chamber proximal to the extending surface can become greater than the hydraulic fluid pressure in the chamber proximal to the retracting surface. For example, the retraction stroke can end and the extension stroke can begin. The foregoing steps of process 300 can be repeated until an actuation of the piston assembly within the cylinder assembly is terminated.

A number of embodiments have been described. Nevertheless, it will be understood that various modifications may be made. Accordingly, other embodiments are within the scope of the following claims. For example, in some implementations, the piston assembly can include either the first unidirectional passage with a check valve or the second unidirectional passage with a check vale but not both.

What is claimed is:

1. A piston assembly disposed in a cylinder assembly of a piston actuator, the piston assembly comprising:
a piston including an extending surface, a retracting surface, and a circumferential surface that connects the extending surface and the retracting surface, the piston adapted to engage and seal against an interior surface of a cylinder bore of an actuator; and
a first unidirectional passage connecting the extending surface and the circumferential surface, the first unidirectional passage allowing hydraulic fluid to flow unidirectionally from the extending surface to the circumferential surface through the piston to energize a circumferential seal disposed on a seal groove in the circumferential surface during an extension stroke of the piston.

2. The piston assembly of claim 1, further comprising a check valve disposed in the first unidirectional passage, the check valve adapted to flow the hydraulic fluid from the extending surface to the circumferential surface and prevent back flow of the hydraulic fluid from the circumferential surface to the extending surface.

3. The piston assembly of claim 1, further comprising a second unidirectional passage connecting the retracting surface and the circumferential surface, the second unidirectional passage allowing hydraulic fluid to flow unidirectionally from the retracting surface to the circumferential surface through the piston to energize the circumferential seal disposed on the seal groove in the circumferential surface during a retraction stroke of the piston.

4. The piston assembly of claim 3, further comprising a check valve disposed in the second unidirectional passage, the check valve adapted to flow the hydraulic fluid from the retracting surface to the circumferential surface and prevent back flow of the hydraulic fluid from the circumferential surface to the retracting surface.

5. The piston assembly of claim 3, wherein an inlet of the first unidirectional passage is positioned in the extending surface diametrically opposite to an inlet of the second unidirectional passage positioned in the retracting surface, and wherein an outlet of the first unidirectional passage is positioned in the circumferential surface diametrically opposite to an outlet of the second unidirectional passage positioned in the circumferential surface.

6. The piston assembly of claim 5, wherein the outlet of the first unidirectional passage terminates in the seal groove and the outlet of the second unidirectional passage terminates in the seal groove.

7. The piston assembly of claim 1, comprising the cylinder bore in which the piston is disposed, wherein the cylinder bore includes a first chamber defined by a front end of the cylinder bore, sidewall of the cylinder bore, and the extending surface of the piston, and a second chamber defined by a rear end of the cylinder bore, the sidewall of the cylinder bore, and the retracting surface of the piston, wherein the first chamber includes a hydraulic fluid port through which the hydraulic fluid is supplied to the first chamber, and wherein the second chamber includes a hydraulic fluid port through which the hydraulic fluid is supplied to the second chamber.

8. The piston assembly of claim 7, wherein the side wall of the bore includes an opening which engages the circumferential seal when the circumferential seal is energized by the hydraulic fluid flowing through the first unidirectional passage.

9. A piston assembly disposed in a cylinder assembly of a piston actuator, the piston assembly comprising:
a piston including a extending surface, a retracting surface, and a circumferential surface that connects the extending surface and the retracting surface;
a cylinder bore of an actuator assembly, the cylinder bore adapted to receive the piston, the cylinder bore including a first chamber formed between a front end of the cylinder bore and the extending surface and a second chamber formed between a rear end of the cylinder bore and the retracting surface when the piston is disposed in the bore intermediate to the front end and the rear end; and
a first unidirectional passage connecting the retracting surface and the circumferential surface, the first unidirectional passage allowing hydraulic fluid in the rear chamber to flow unidirectionally in the cylinder bore from the retracting surface to the circumferential surface through the piston to energize a circumferential seal disposed in a seal groove in the circumferential surface during a retraction stroke of the piston.

10. The piston assembly of claim 9, comprising a second unidirectional passage connecting the extending surface and the circumferential surface, the second unidirectional passage allowing hydraulic fluid in the front chamber to flow unidirectionally from the extending surface to the circumferential surface through the piston to energize the circumferential seal disposed in the seal groove in the circumferential surface during an extension stroke of the piston.

11. The piston assembly of claim 10, further comprising a check valve disposed in the second unidirectional passage adapted to allow the hydraulic fluid in the front chamber to flow from the extending surface to the circumferential surface and prevent back flow from the circumferential surface to the extending surface.

12. The piston assembly of claim 10, wherein an inlet of the first unidirectional passage is positioned in the retracting surface diametrically opposite to an inlet of the second unidirectional passage positioned in the extending surface, and wherein an outlet of the first unidirectional passage is positioned in the circumferential surface diametrically opposite to an outlet of the second unidirectional passage positioned in the circumferential surface.

13. The piston assembly of claim 9, further comprising a check valve disposed in the first unidirectional passage that allows the hydraulic fluid in the rear chamber to flow from the retracting surface to the circumferential surface and prevents back flow from the circumferential surface to the retracting surface.

14. The piston assembly of claim 10, wherein the cylinder bore includes a circumferential wall that connects the front end and the rear end, and wherein the circumferential wall includes an opening which engages the circumferential seal when the circumferential seal is energized by the hydraulic fluid flowing through the first unidirectional passage.

15. A method to energize a seal on a piston, the method comprising:
receiving hydraulic fluid in an inlet of a first unidirectional passage, said inlet of the first unidirectional passage disposed in an extending surface of a piston disposed in a cylinder bore of a piston actuator, said extending surface connected to a retracting surface of the piston by a circumferential surface, wherein the hydraulic fluid is received in the inlet of the first unidirectional passage when a hydraulic fluid pressure in a first chamber proximal to the extending surface is greater than a hydraulic fluid pressure in a second chamber proximal to the retracting surface;
flowing the hydraulic fluid unidirectionally from the inlet of the first unidirectional passage in the extending surface to an outlet of the first unidirectional passage, said outlet of the first unidirectional passage disposed in the circumferential surface of the piston; and
energizing a circumferential seal disposed on a seal groove in the circumferential surface.

16. The method of claim 15, further comprising:
receiving hydraulic fluid in an inlet of a second unidirectional passage, said inlet of the second unidirectional passage disposed in the retracting surface of the piston, wherein the hydraulic fluid is received in the inlet of the second unidirectional passage when the hydraulic fluid pressure in the second chamber is greater than the hydraulic fluid pressure in the first chamber;
flowing the hydraulic fluid unidirectionally from the inlet of the second unidirectional passage in the retracting surface to an outlet of the second unidirectional passage, said outlet of the second unidirectional passage disposed in the circumferential surface of the piston; and
energizing the circumferential seal disposed on the seal groove in the circumferential surface.

17. The method of claim 16, wherein flowing the hydraulic fluid unidirectionally from the inlet of the second unidirectional passage includes flowing the hydraulic fluid through a check valve disposed in the second unidirectional passage.

18. The method of claim 16, wherein receiving the hydraulic fluid in the inlet of the second unidirectional passage comprises receiving the hydraulic fluid in the inlet of the second unidirectional passage during a retraction stroke of the piston.

19. The method of claim 15, wherein flowing the hydraulic fluid unidirectionally from the inlet of the first unidirectional passage includes flowing the hydraulic fluid through a check valve disposed in the first unidirectional passage.

20. The method of claim 15, wherein receiving the hydraulic fluid in the inlet of the first unidirectional passage comprises receiving the hydraulic fluid in the inlet of the first unidirectional passage during an extension stroke of the piston.
